(19) United States
(12) Patent Application Publication
(10) Pub. No.: US 2015/0220632 A1
(43) Pub. Date: Aug. 6, 2015

(54) DICTIONARY CREATION DEVICE FOR MONITORING TEXT INFORMATION, DICTIONARY CREATION METHOD FOR MONITORING TEXT INFORMATION, AND DICTIONARY CREATION PROGRAM FOR MONITORING TEXT INFORMATION

(71) Applicant: NEC Corporation, Minato-ku, Tokyo (JP)

(72) Inventors: Takashi Onishi, Tokyo (JP); Masaaki Tsuchida, Tokyo (JP); Kai Ishikawa, Tokyo (JP)

(73) Assignee: NEC Corporation, Minato-ku, Tokyo (JP)

(21) Appl. No.: 14/429,450

(22) PCT Filed: Sep. 26, 2013
(86) PCT No.: PCT/JP2013/076094

§ 371 Date: Mar. 19, 2015

(30) Foreign Application Priority Data
Sep. 27, 2012 (JP) 2012-213536

(51) Int. Cl. G06F 17/30

(52) U.S. Cl. CPC G06F 17/30737

(57) ABSTRACT

The purpose of the present invention is to generate a dictionary for monitoring text information such that it is possible to achieve high-precision detection compared to conventional art. A feature degree calculation unit 3 compares the statistics of a positive example group and a negative example group, and calculates the degree by which a phase of interest appears in the positive example group as the feature degree. A usefulness degree calculation unit 21 calculates a usefulness degree by using the length of the phrase, the frequency at which the phrase appears within the positive example group, and an index pertaining to an inclusion relationship between phrases for each phrase extracted by means of a phrase extraction unit 1. A detection condition determination unit 22 uses the usefulness degree calculated by means of the usefulness degree calculation unit 21 and the feature degree calculated by means of the feature degree calculation unit 3 to evaluate the appropriateness of each phrase as a detection condition by means of the product of the usefulness degree and the feature degree, and determines that the phrase is appropriate for a detection condition when the value of the product is greater than a threshold value.

### TECHNICAL FIELD

The present invention relates to dictionary generation devices for monitoring text information, dictionary generation methods for monitoring text information, and dictionary generation programs for monitoring text information. In particular, the present invention relates to a dictionary generation device for monitoring text information, a dictionary generation method for monitoring text information, and a dictionary generation program for monitoring text information, by which a dictionary for monitoring text information with high precision even for unknown text is generated.

### BACKGROUND ART

For monitoring of rumors on the Internet, and the like, text information monitoring technologies by which information contents targeted for monitor are detected appearing from a large amount of text have become important. Text information monitoring systems assumed in the present invention monitor text information on the basis of dictionaries. In other words, as a technique of the text information monitor technologies, there is used a dictionary-based technique in which conditions for detection are maintained in a dictionary for monitoring text information and it is detected whether or not an expression in an input document matches the conditions in the dictionary for monitoring text information.

In the dictionary-based technique, text information can be monitored with high precision by using a high-precision dictionary. Thus, it is important that the high-precision dictionary is used.

Generation of a dictionary with introspection in a text information monitoring system based on a dictionary consumes time, is prone to result in omission, and is therefore difficult. Thus, there is desired a technique of giving a positive example group, in which documents including an information content targeted for monitor are gathered, and a negative example group, in which documents that do not include the information content targeted for monitor are gathered, to automatically extract an expression to be registered as a detection condition from the groups. Conventional techniques of such a method include a feature word extraction technique. The feature word extraction technique is a technique that compares a positive example group and a negative example group to extract, as a feature word, a word that characteristically appears in the positive example group.

An example of such a technique is PTL 1. In PTL 1, when a dictionary used in text mining is constructed, document data targeted for analysis is divided into groups, and expressions that characteristically appear in each group are used as dictionary candidates.

### CITATION LIST

### Patent Literature

[PTL 1]: Japanese Patent Laid-Open No. 2009-015394

### SUMMARY OF INVENTION

### Technical Problem

However, a feature word extraction technique with a short unit at a word or modification level in the conventional art is unable to sufficiently satisfy the performance requirements of a text information monitoring system. This is because detection precision is decreased only with a short unit at a word or modification level. For example, even if one word “virus” is registered in a dictionary for monitoring text information in order to detect a description about a computer virus, a document including, e.g., “cold virus” is detected mistakenly. In this case, it is necessary to register a phrase including one or more words, such as “computer virus” or “virus email”, in the dictionary for monitoring text information.

As described above, an optimal phrase length depends on what to intend to detect, and therefore, it is impossible to decide the length as a unique value in advance. Thus, it is necessary to extract phrases with any lengths as candidates and to calculate a feature degree for each phrase in order to handle a phrase with a variable length. Further, it is impossible to appropriately handle a case in which plural phrases overlapping each other are output at an equal feature degree.

For example, phrases as represented in FIG. 4 are extracted and “Trojan horse”, “Trojan”, and “horse” are extracted at an equal feature degree (=3) by carrying out feature word extraction for phrases with various lengths when positive and negative example groups as represented in FIG. 3 are given. However, although neither “Trojan” nor “horse” appears in the negative example group, since expressions, such as “Trojan heritage” and “carousel horse”, irrelevant to the virus, are conceivable, the registration of “Trojan” and “horse” in a dictionary for monitoring text information results in lower detection precision. Theoretically, the appearance of an expression such as “Trojan heritage” or “carousel horse” in a negative example group can result in the lower feature degree of an expression such as “Trojan” or “horse” and also in lower detection precision. However, in reality, a negative example group with a sufficient amount is rarely obtained, and such a problem as described above occurs frequently.

In PTL 1, a technique in which a word collocating with a feature word is also regarded as a dictionary registration candidate is disclosed; however, an index such as the product of TF (Term Frequency) and IDF (Inverse Document Frequency) is used in determination whether or not to carry out dictionary registration, and it is considered that there is such a problem as described above for plural phrases overlapping each other.

As described above, conventional techniques in which a dictionary for monitoring text information is constructed with a feature degree calculated from a positive example group and a negative example group have a problem that lower detection precision is caused.

The present invention is to solve the problems described above and to provide a dictionary generation device for monitoring text information, a dictionary generation method for monitoring text information, and a dictionary generation program for monitoring text information such that it is possible to achieve high-precision detection compared to the conventional art.

### Solution to Problem

The present invention which is to solve the problems described above is a dictionary generation device for monitoring text information, which is used in a text information monitoring system and generates a dictionary in which a detection condition is registered, including: a feature degree calculation unit that calculates, for a phrase as a candidate for the detection condition, a feature degree representing a degree by which the phrase matches an information content targeted for monitor; and a phrase usefulness determination unit that determines whether or not the phrase is appropriate for the detection condition based on the feature degree and a usefulness degree representing littleness of ambiguity of meaning defined by the phrase.

The present invention which is to solve the problems described above is a method for generating a dictionary used in a text information monitoring system, wherein a dictionary generation device for monitoring text information calculates, for a phrase as a candidate for a detection condition, a feature degree representing a degree by which the phrase matches an information content targeted for monitor; determines whether or not the phrase is appropriate for the detection condition based on the feature degree and a usefulness degree representing littleness of ambiguity of meaning defined by the phrase; and outputs a phrase judged to be appropriate and registers the phrase as the detection condition.

The present invention which is to solve the problems described above is a dictionary generation program for monitoring text information, which allows a dictionary generation device for monitoring text information to execute a processing of calculating, for a phrase as a candidate for a detection condition, a feature degree representing a degree by which the phrase matches an information content targeted for monitor; a processing of determining whether or not the phrase is appropriate for the detection condition based on the feature degree and a usefulness degree representing littleness of ambiguity of meaning defined by the phrase; and a processing of outputting a phrase judged to be appropriate and of registering the phrase as the detection condition.

### Advantageous Effects of Invention

In general, the longer length of a phrase results in the less ambiguity of meaning and in a higher matching rate for a detection condition. In the present invention, a usefulness degree is calculated based on the length of a phrase, and a phrase to be registered in a dictionary is extracted based on the usefulness degree and a feature degree. In other words, priority is given to a phrase having a longer length.

As a result, there can be generated a dictionary for monitoring text information such that it is possible to achieve high-precision detection compared to the conventional art.

### BRIEF DESCRIPTION OF DRAWINGS

FIG. 1 is a functional block diagram of a dictionary generation device.

FIG. 2 is an operation flow of a dictionary generation device.

FIG. 3 is an example of a positive example group and a negative example group (common to the conventional art).

FIG. 4 is an example of the frequency and feature degree of each phrase (common to the conventional art).

FIG. 5 is an example of the usefulness degree and score of each phrase (Application Example 1).

FIG. 6 is an example of the usefulness degree and score of each phrase (Application Example 2).

FIG. 7 is an example of the usefulness degree and score of each phrase (Application Example 3).

FIG. 8 is an example of the usefulness degree and score of each phrase (Application Example 4).

FIG. 9 is an example of the usefulness degree and score of each phrase (Application Example 5).

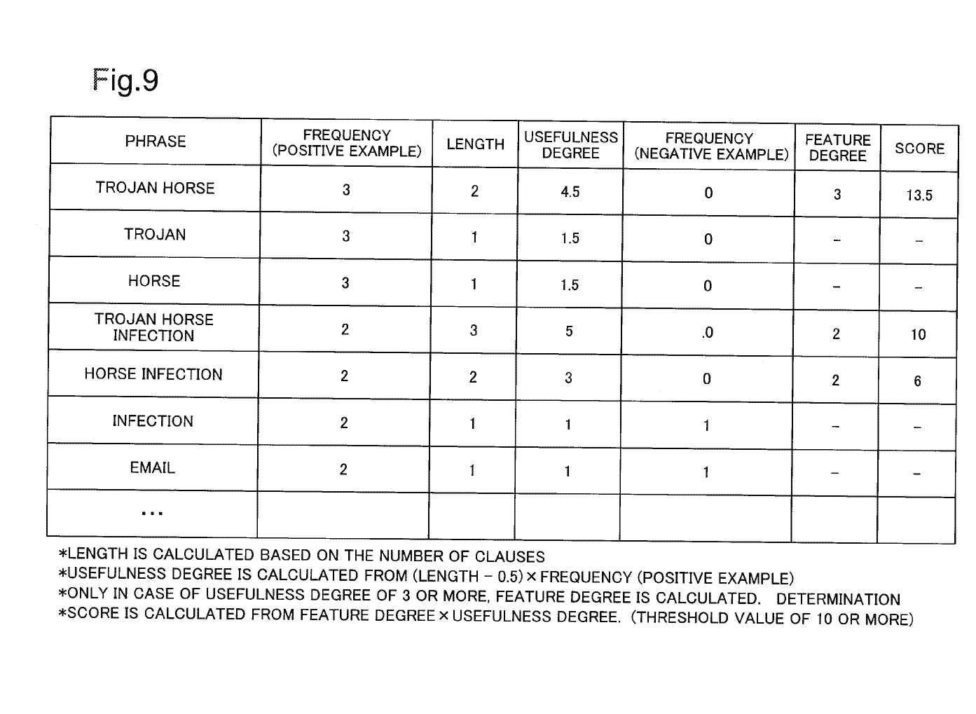

### DESCRIPTION OF EMBODIMENTS

Configuration/Operation

The configurations and operations of exemplary embodiments of the present invention will be explained in detail below with reference to the drawings.

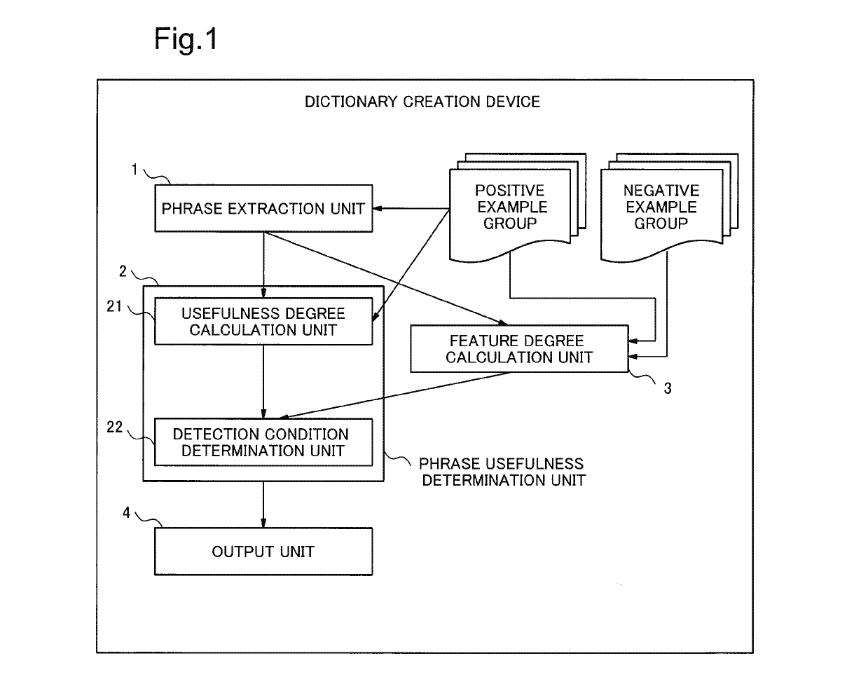

FIG. 1 is a functional block diagram of a dictionary generation device according to the present exemplary embodiment. The dictionary generation device according to the present exemplary embodiment includes a phrase extraction unit 1, a phrase usefulness determination unit 2, a feature degree calculation unit 3, and an output unit 4. The phrase usefulness determination unit 2 includes a usefulness degree calculation unit 21 and a detection condition determination unit 22.

The function of each configuration will be explained.

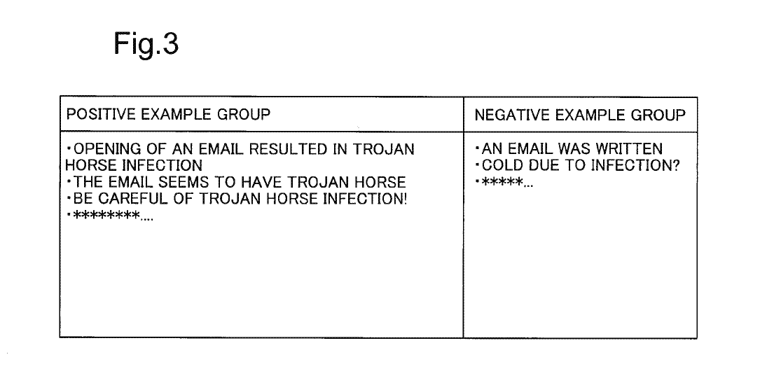

It is assumed that a positive example group, in which documents including an information content targeted for monitor are collected, and a negative example group, in which documents that do not include the information content targeted for monitor are collected, are given (see FIG. 3).

The phrase extraction unit 1 performs language analysis for text in the given positive example group extracts phrases having various lengths as candidates for a detection condition. The phrases are extracted by carrying out morphological analysis to extract the phrases as specific part-of-speech tag strings, by carrying out syntactic analysis to regard subtrees of obtained syntactic trees as the phrases, or by using a combination of the analyses.

The phrase usefulness determination unit 2 calculates the usefulness degree of each phrase extracted in the phrase extraction unit 1, and further determines whether the phrase is appropriate for the detection condition by combining the usefulness degree and a feature degree calculated by the feature degree calculation unit 3, and.

The usefulness degree calculation unit 21 calculates a usefulness degree by using the length of the phrase, the frequency at which the phrase appears within the positive example group, and an index pertaining to an inclusion relationship between phrases for each phrase extracted by the phrase extraction unit 1. As used herein, the usefulness degree of a phrase refers to a value representing the littleness of the ambiguity of meaning defined by the phrase and to a value representing detection precision in a case in which the phrase is regarded as a detection condition. As the usefulness degree, the length of the phrase or the logarithmic value thereof may be used, or the product of the length of the phrase or the logarithmic value thereof and the number of the appearances of the phrase in the positive example group or the logarithmic value thereof may be used. Alternatively, as the usefulness degree, such a C-value as proposed in NPL 1 may be further used based on the index pertaining to the inclusion relationship between phrases.
NPL 1: Frantzi, K. and Ananiadou, S. (1996). “Extracting Nested Collocations.” In Proceedings of the 16th International Conference on Computational Linguistics (COLING 96), pp. 41-46.

Application examples of a usefulness degree calculation will be mentioned later (Application Examples 1 to 4).

For each phrase, the detection condition determination unit 22 determines whether or not the phrase is appropriate for the detection condition by using the usefulness degree calculated by the usefulness degree calculation unit 21 and the feature degree calculated by the feature degree calculation unit 3. For example, the detection condition determination unit 22 evaluates the appropriateness as the detection condition with the product of the usefulness degree and the feature degree, and determines that the phrase is appropriate for the detection condition in a case in which the value of the product is greater than a threshold value. The detection condition determination unit 22 can also exclude phrases, of which the usefulness degrees are less than the threshold value, to reduce phrases of which the feature degrees are calculated and to reduce a calculation amount (Application Example 5).

The feature degree calculation unit 3 compares the statistics of the positive example group and the negative example group, and calculates the degree by which a phrase of interest appears in the positive example group as the feature degree. The feature degree is calculated by using an existing measure, such as a chi-square value, a mutual information content, or ESC (Extended Stochastic Complexity), used in text mining. The calculation of the feature degree in this case may be carried out for all the phrases extracted in the phrase extraction unit 1 or only for phrases necessary for determination in the phrase usefulness determination unit 2.

The output unit 4 outputs, as a phrase to be registered in a dictionary, a phrase judged to be appropriate for the detection condition by the phrase usefulness determination unit 2. The output unit 4 not only outputs only a phrase to be registered in the dictionary but also outputs the phrase together with a usefulness degree, a feature degree, a score representing appropriateness as the detection condition, and the like, whereby phrases to be registered in the dictionary using manpower with reference to the score and the like can be sorted to lighten an operation for constructing a dictionary for monitoring text information.

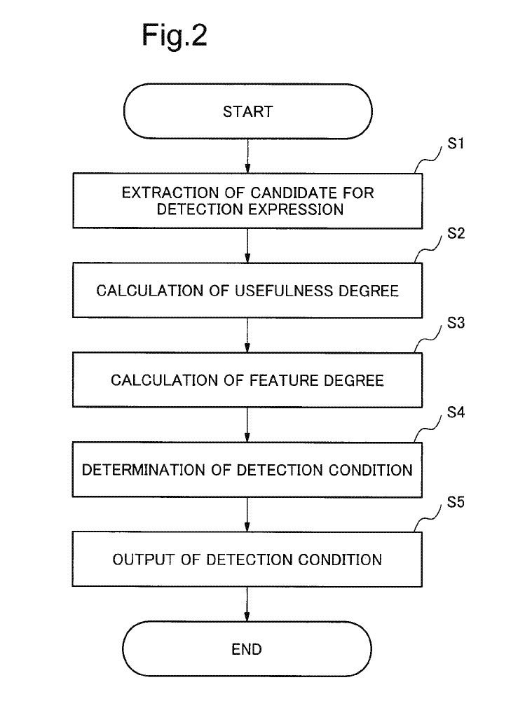

FIG. 2 is an operation flow of a dictionary generation device. A dictionary generation program allows the dictionary generation device to execute each processing of the operation flow. When the program is executed, the phrase extraction unit 1, the phrase usefulness determination unit 2, the feature degree calculation unit 3, and the output unit 4 are operated.

First, the phrase extraction unit 1 subjects text in a given positive example group to language analysis to extract phrases having various lengths as candidates for a detection condition (step S1).

Then, the usefulness degree calculation unit 21 calculates the usefulness degree of each phrase extracted by the phrase extraction unit 1 (step S2).

On the other hand, the feature degree calculation unit 3 calculates the feature degree of a phrase of interest (step S3).

Then, for each phrase, the detection condition determination unit 22 determines whether or not the phrase is appropriate for the detection condition by using the usefulness degree calculated by the usefulness degree calculation unit 21 and the feature degree calculated by the feature degree calculation unit 3 (step S4). For example, the detection condition determination unit 22 calculates a score based on the usefulness degree and the feature degree, and carries out the determination based on the score.

Finally, the output unit 4 outputs a phrase to be registered in a dictionary (step S5), and the processing is finished.

Either of step S2 and step 3 may be carried out earlier, or the steps may be carried out simultaneously.

In step S3 and step S4, the feature degree of only a phrase of which the usefulness degree is not less than the threshold value may also be calculated to determine whether or not the phrase is appropriate for the detection condition.

Specific Example of Conventional Art

The dictionary creation device according to the conventional art includes a phrase extraction unit 1, a feature degree calculation unit 3, and an output unit 4 (illustration is omitted). In other words, the dictionary generation device according to the conventional art is common to the present exemplary embodiment except the presence or absence of the phrase usefulness determination unit 2.

The text information monitoring system according to the present invention matches a character string with the dictionary for monitoring text information to thereby monitor text information and to register the character string as a detection condition in the dictionary for monitoring text information. However, the text information monitoring system according to the present invention is not limited to the above-described system, and the present invention is also effective in a system that monitors text information with a part-of-speech tag or a syntactic structure as a condition.

The dictionary generation device generates a dictionary used in the dictionary for monitoring text information.

FIG. 3 is an example of the positive example group and the negative example group. It is assumed that such positive and negative example groups are given.

First, the phrase extraction unit 1 extracts a candidate for a detection condition from the positive example group. For example, when all phrases having three or less chunks are extracted from the positive example group of FIG. 3, the phrases such as “Trojan horse”, “Trojan”, “horse”, “Trojan horse infection”, “horse infection”, “infection”, and “email” are extracted as candidates for detection conditions.

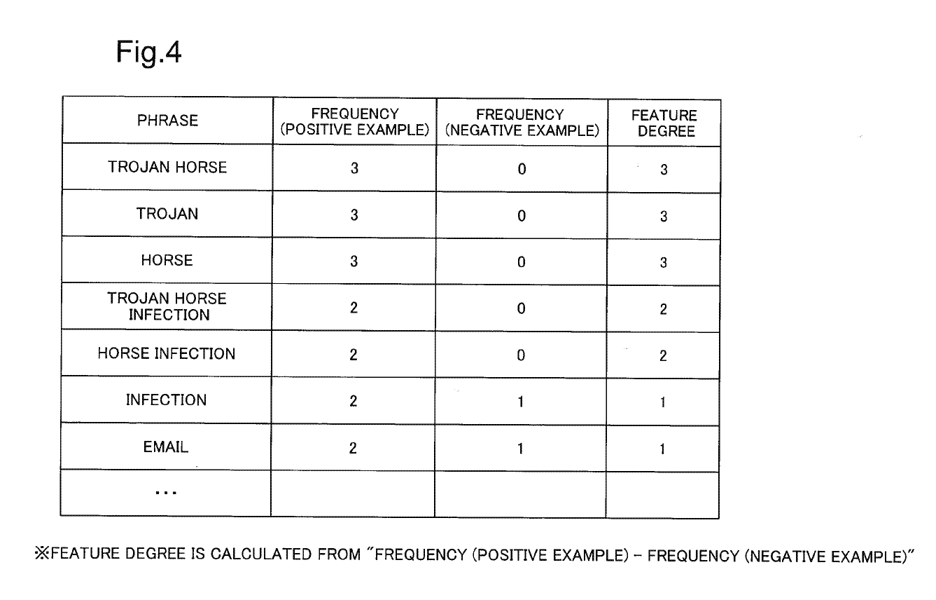

Then, the feature degree calculation unit 3 calculates the feature degree of each candidate for a detection condition. FIG. 4 is an example of the frequency and feature degree of each phrase. For example, assuming that a feature degree is calculated by

feature degree=(frequency in positive example group)−(frequency in negative example group)

it is calculated that the feature degree of “Trojan horse” is 3, the feature degree of “Trojan” is 3, the feature degree of “horse” is 3, the feature degree of “Trojan horse infection” is 2, the feature degree of “horse infection” is 2, the feature degree of “infection” is 1, and the feature degree of “email” is 1.

The output unit 4 outputs, for example, the phrases “Trojan horse”, “Trojan”, and “horse”, having the high feature degrees, and registers the phrases in the dictionary.

### Specific Application Example 1

The operations of the phrase extraction unit 1 and the feature degree calculation unit 3 are similar to those of the conventional art. In other words, candidates for detection conditions are extracted from a positive example group, and the feature degree of each candidate for a detection condition is calculated.

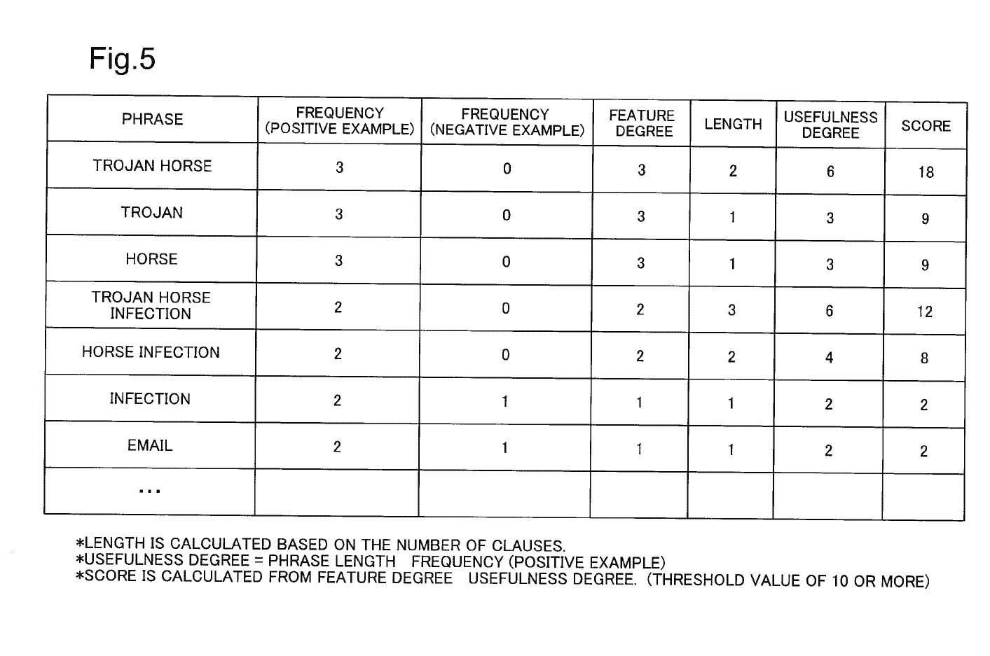

Further, the usefulness degree calculation unit 21 calculates the usefulness degree of each candidate for a detection condition. FIG. 5 is an example of the usefulness degree and score of each phrase (mentioned later). For example, the usefulness degree is calculated based on the product of the length of a phrase and a frequency in the positive example group. In other words, when the usefulness degree is calculated by

usefulness degree=(length of the phrase)×(frequency in positive example group)

it is calculated that the usefulness degree of “Trojan horse” is 6, the usefulness degree of “Trojan” is 3, the usefulness degree of “horse” is 3, the usefulness degree of “Trojan horse infection” is 6, the usefulness degree of “horse infection” is 4, the usefulness degree of “infection” is 2, and the usefulness degree of “email” is 2. In this case, the length of each phrase is calculated based on the number of chunks. In addition to the number of chunks, however, the length may also be calculated based on the number of morphemes, the number of characters, a byte length, and the like.

Then, the detection condition determination unit 22 evaluates each candidate for a detection condition (see FIG. 5). For example, the detection condition determination unit 22 calculates a score representing appropriateness for the detection condition based on the product of a usefulness degree and a feature degree. In other words, when the score is calculated by

score=feature degree×usefulness degree

the detection condition determination unit 22 calculates that the score of “Trojan horse” is 18, the score of “Trojan” is 9, the score of “horse” is 9, the score of “Trojan horse infection” is 12, the score of “horse infection” is 8, the score of “infection” is 2, and the score of “email” is 2. For example, when phrases having a score of 10 or more are adopted as the detection conditions, the detection condition determination unit 22 determines that two of “Trojan horse” and “Trojan horse infection” are appropriate for the detection conditions.

The output unit 4 outputs the phrases “Trojan horse” and “Trojan horse infection” based on the determination results from the detection condition determination unit 22, and registers the phrases in the dictionary.

Effect

The effect of the present exemplary embodiment will be explained in comparison with the conventional art.

In the conventional art in which a detection condition is determined based only on a feature degree, “Trojan horse”, “Trojan”, and “horse” have feature degree=3, which is maximum, and are detection conditions. However, expressions, such as “Trojan heritage” for “Trojan” and “carousel horse” for “horse”, which are not intrinsically intended to be detected are detected, so that detection precision are decreased.

In contrast, in the present exemplary embodiment, the phrase usefulness determination unit 2 uses the length of a phrase as a candidate to calculate a usefulness degree representing goodness for a detection condition in a case in which the phrase is the detection condition. The phrase usefulness determination unit 2 determines a phrase to be registered in the dictionary by using the obtained usefulness degree and a feature degree that is separately calculated.

In general, the longer length of a phrase results in the less ambiguity of meaning and in a higher matching rate for a detection condition. Thus, higher-precision detection than that in the case of using only a feature degree is enabled by selecting a phrase having a long length in a case in which phrases that overlap each other have an equal feature degree.

In addition to the length of a phrase, the frequency at which the phrase appears within a document group is further used to calculate a usefulness degree. The longer length of the phrase results in a higher matching rate but is considered to result in a lower recall rate since the appearance probability of the phrase is decreased. Thus, the consideration of the frequency as well as the length of the phrase allows a usefulness degree, at which a matching rate and a recall rate are balanced, to be calculated, and enables higher-precision detection.

In the present exemplary embodiment, “Trojan horse” and “Trojan horse infection” are detection conditions, and neither “Trojan” nor “horse” is registered in the dictionary. As a result, higher-precision detection than that in the conventional art can be achieved.

### Specific Application Example 2

In Application Example 1 as described above, the usefulness degree calculation unit 21 calculates usefulness degrees based on the products of the lengths of phrases and frequencies in a positive example group; however, when the differences between the usefulness degrees are intended to be more significant, a correction value may be subtracted from the lengths of the phrases.

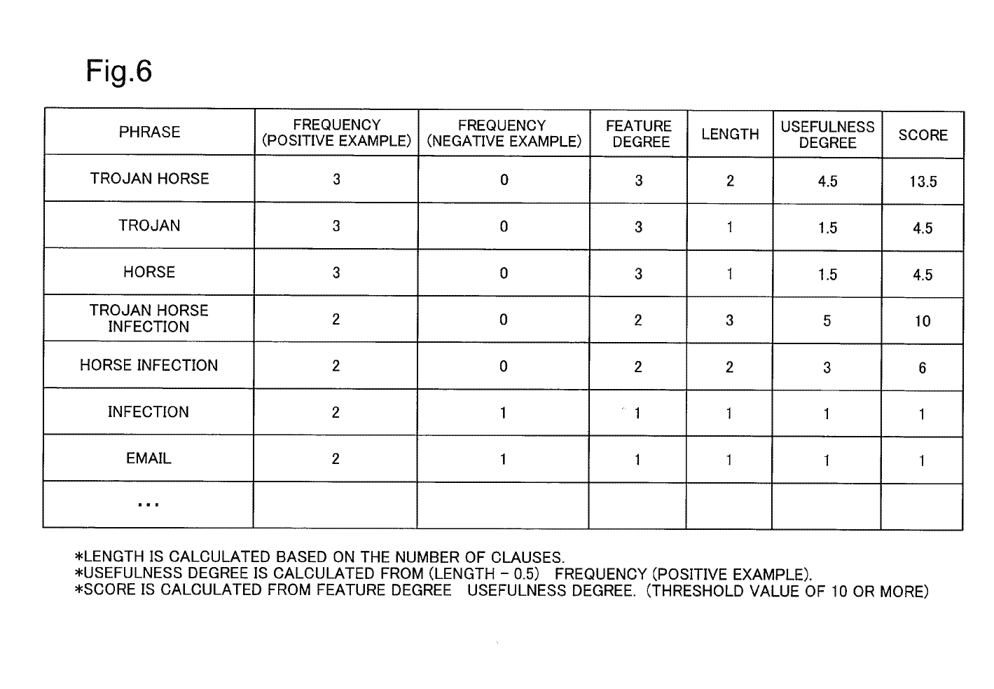

FIG. 6 is another example of the usefulness degree and score of each phrase. For example, the usefulness degree calculation unit 21 calculates a usefulness degree based on the product of a value, obtained by subtracting a correction value from the length of a phrase, and a frequency in a positive example group. The correction value may be determined experientially. In this example, the correction value is assumed to be “−0.5”. In other words, in the case of calculation by

usefulness degree=(length of phrase−0.5)×(frequency in positive example group)

it is calculated that the usefulness degree of “Trojan horse” is 4.5, the usefulness degree of “Trojan” is 1.5, the usefulness degree of “horse” is 1.5, the usefulness degree of “Trojan horse infection” is 5, the usefulness degree of “horse infection” is 3, the usefulness degree of “infection” is 1, and the usefulness degree of “email” is 1.

As described above, the length of a phrase is corrected to be more emphasized.

Then, the detection condition determination unit 22 calculates, from score=feature degree×usefulness degree, that the score of “Trojan horse” is 13.5, the score of “Trojan” is 4.5, the score of “horse” is 4.5, the score of “Trojan horse infection” is 10, the score of “horse infection” is 6, the score of “infection” is 1, and the score of “email” is 1. For example, when phrases having a score of 10 or more are adopted for detection conditions, the detection condition determination unit 22 determines that two of “Trojan horse” and “Trojan horse infection” are appropriate for the detection conditions.

In comparison with Application Example 1, the rate of the score of “Trojan” or “horse” is decreased with respect to the score of “Trojan horse”. In other words, “Trojan horse” is more reliably registered in a dictionary, and “Trojan” and “horse” are more reliably excluded from dictionary registration. As a result, precision is improved.

### Specific Application Example 3

In Application Example 1 and Application Example 2 as described above, the detection condition determination unit 22 is set to adopt a phrase having a score of 10 or more as a detection condition, and therefore, “horse infection” is not registered in a dictionary but can be registered depending on settings. “Horse infection” is included in “Trojan horse infection”, and is used as the expression of “Trojan horse infection”, so-called a set phrase, in most cases. Thus, there is no point in registering both “horse infection” and “Trojan horse infection” in the dictionary.

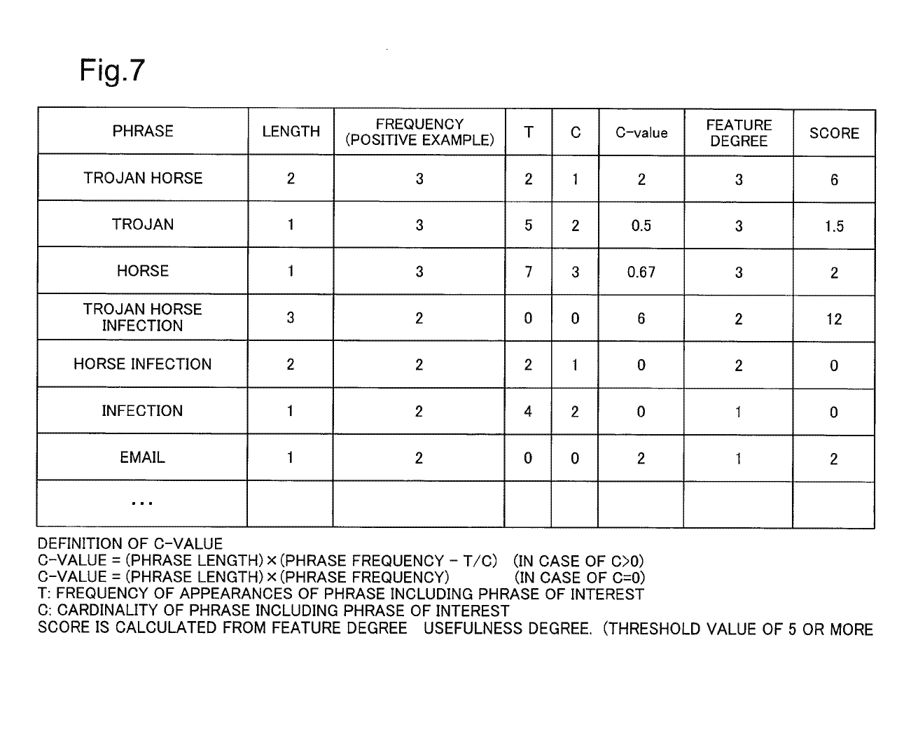

Thus, the usefulness degree calculation unit 21 calculates a usefulness degree based on an index representing an inclusion relationship between phrases as well as the length of a phrase and a frequency in a positive example group. For example, a C-value may be assumed to be the usefulness degree. The C-value is a value calculated from the following expression. FIG. 7 is another example of the usefulness degree (C-value) and score of each phrase.

Definition of C-Value

C-value=(phrase length)×(frequency in positive example group−T/C) (in case of C>0)

C-value=(phrase length)×(frequency in positive example group) (in case of C=0)

T: Total of the frequency of appearance of a phrase that includes a phrase of interest and is longer than the phrase of interest

C: Cardinality of phrases that include a phrase of interest and are longer than the phrase of interest (i.e., the number of such phrases)

T and C will be specifically explained below (see FIG. 7).

### Phrase of Interest: “Trojan Horse”

Phrase that includes the phrase of interest and is longer than the phrase of interest: “Trojan horse infection”

T=2: Frequency of appearance of “Trojan horse infection”: 2

C=1: Phrase that includes the phrase of interest and is longer than the phrase of interest: 1

### Phrase of Interest: “Trojan”

Phrases that include the phrase of interest and are longer than the phrase of interest: “Trojan horse” and “Trojan horse infection”

T=3+2=5: Frequency of appearance of “Trojan horse”: 3, and frequency of appearance of “Trojan horse infection”: 2

C=2: Phrases that include the phrase of interest and are longer than the phrase of interest: 2

### Phrase of Interest: “Horse”

Phrases that include the phrase of interest and are longer than the phrase of interest: “Trojan horse”, “Trojan horse infection”, and “horse infection”
T=3+2+2=7: Frequency of appearance of “Trojan horse”: 3, frequency of appearance of “Trojan horse infection”: 2, and frequency of appearance of “horse infection”: 2
C=3: phrases that include the phrase of interest and are longer than the phrase of interest: 3

### Phrase of Interest: “Trojan Horse Infection”

Phrase that includes the phrase of interest and is longer than the phrase of interest: none

T=0

C=0

### Phrase of Interest: “Horse Infection”

Phrase that includes the phrase of interest and is longer than the phrase of interest: “Trojan horse infection”

T=2: Frequency of appearance of “Trojan horse infection”: 2

C=1: Phrase that includes the phrase of interest and is longer than the phrase of interest: 1

### Phrase of Interest: “Infection”

Phrases that include the phrase of interest and are longer than the phrase of interest: “Trojan horse infection” and “horse infection”
T=2+2=4: Frequency of appearance of “Trojan horse infection”: 2, and frequency of appearance of “horse infection”: 2
C=2: phrases that include the phrase of interest and are longer than the phrase of interest: 2

### Phrase of Interest: “Email”

Phrase that includes the phrase of interest and is longer than the phrase of interest: none

T=0

C=0

Due to the correction with T and C, it is calculated that the usefulness degree of “Trojan horse” is 2, the usefulness degree of “Trojan” is 0.5, the usefulness degree of “horse” is 0.67, the usefulness degree of “Trojan horse infection” is 6, the usefulness degree of “horse infection” is 0, the usefulness degree of “infection” is 0, and the usefulness degree of “email” is 2.

The usefulness degree of “Trojan horse infection” is 6 whereas the usefulness degree of “horse infection” is 0. The results show that since “horse infection” is a set phrase that is necessarily used as the expression of “Trojan horse infection” in a positive example document group, the term property of “horse infection” is low, and there is no point in adding “horse infection” as a condition if “Trojan horse infection” exists as a detection condition.

On the other hand, the usefulness degree of “Trojan horse” is 2. Since “Trojan horse” has usage examples other than “Trojan horse infection”, the term property and C-value of “Trojan horse” are higher than those of “horse infection”.

A term property is an index representing the easiness of use as a group of phrases. A high term property means easy use as a group of phrases.

Use of a C-value as a usefulness degree as described above results in the lower value of a phrase included in another longer phrase, eliminates addition of a redundant detection condition, and enables improvement of dictionary precision.

Then, the detection condition determination unit 22 calculates, from score=feature degree×usefulness degree, that the score of “Trojan horse” is 6, the score of “Trojan” is 1.5, the score of “horse” is 2, the score of “Trojan horse infection” is 12, the score of “horse infection” is 0, the score of “infection” is 0, and the score of “email” is 2. For example, when phrases having a score of 5 or more are adopted as detection conditions, the detection condition determination unit 22 determines that two of “Trojan horse” and “Trojan horse infection” are appropriate for the detection conditions.

### Specific Application Example 4

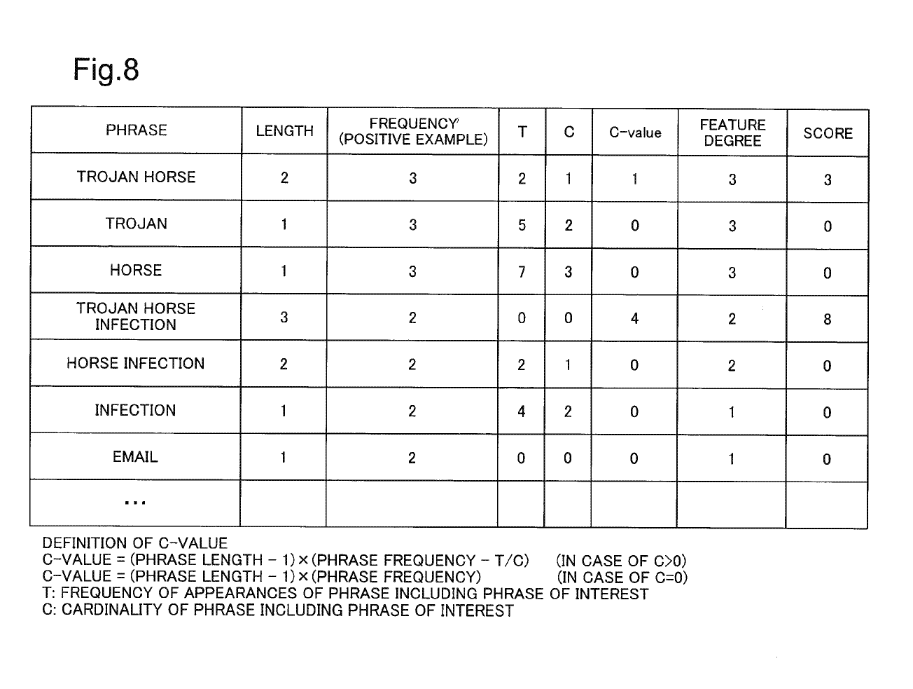

In Application Example 3, a correction value as explained in Application Example 2 may be used. In this example, the correction value is assumed to be “−1”. FIG. 8 is another example of the usefulness degree (C-value) and score of each phrase.

Definition of C-Value

C-value=(phrase length−1)×(frequency in positive example group−T/C) (in case of C>0)

C-value=(phrase length−1)×(frequency in positive example group) (in case of C=0)

T: Total of the frequency of appearance of a phrase that includes a phrase of interest and is longer than the phrase of interest

C: Cardinality of phrases that include a phrase of interest and are longer than the phrase of interest (i.e., the number of such phrases)

The value “−1” in the terms of the phrase lengths is similar to the correction value “−0.5” described in Application Example 2. In other words, the value “−1” is a correction value for more emphasizing the length of a phrase.

As a result, the differences between usefulness degrees become more significant.

### Application Example 5

Only for phrases of which the usefulness degrees are not less than a threshold value, the feature degree calculation unit 3 calculates the feature degrees of the phrases, and the detection condition determination unit 22 determines whether or not the phrases are appropriate for detection conditions.

Specific explanation will be given in comparison with Application Example 2. FIG. 8 is another example of the usefulness degree and score of each phrase.

Similarly to Application Example 2, the usefulness degree calculation unit 21 calculate that the usefulness degree of “Trojan horse” is 4.5, the usefulness degree of “Trojan” is 1.5, the usefulness degree of “horse” is 1.5, the usefulness degree of “Trojan horse infection” is 5, the usefulness degree of “horse infection” is 3, the usefulness degree of “infection” is 1, and the usefulness degree of “email” is 1.

The feature degree calculation unit 3 calculates the feature degrees of, for example, only the phrases having a usefulness degree of 3 or more: “Trojan horse”, “Trojan horse infection”, and “horse infection”. Then, the detection condition determination unit 22 calculates, from score=feature degree×usefulness degree, that the score of “Trojan horse” is 13.5, the score of “Trojan horse infection” is 10, and the score of “horse infection” is 6. For example, when phrases having a score of 10 or more are adopted as detection conditions, the detection condition determination unit 22 determines that two of “Trojan horse” and “Trojan horse infection” are appropriate for the detection conditions.

All the phrases (seven phrases) are subjected to feature degree calculation and determination in Application Example 2, whereas only the three phrases “Trojan horse”, “Trojan horse infection”, and “horse infection” are subjected to feature degree calculation and determination in Application Example 5. However, Application Example 2 and Application Example 5 have the same determination results and equal precision.

As a result, a calculation amount can be reduced while maintaining precision.

Supplement

Application Example 1 mainly explains the details of claim 4 and claim 7. Application Example 2 mainly explains claim 3 except claim 4. Application Examples 3 and 4 mainly explain claim 5 and claim 6. Application Example 5 mainly explains claim 8.

The present invention is a device for generating a dictionary used in a text information monitoring system, and can also be applied to a rumor monitoring system or a reputation extraction system, targeted for the Internet, or the like.

Supplemental Notes

In the exemplary embodiments described above, each unit may be constructed with hardware, or may be achieved by a computer program. In this case, functions and operations similar to those mentioned above are achieved by a processor operated by the program stored in a program memory. Only some functions may also be achieved by the computer program.

Some or all of the exemplary embodiments described above can also be described as in the following supplemental notes, but are not limited to the following.

The present invention is a dictionary generation device for monitoring text information, which is used in a text information monitoring system and generates a dictionary in which a detection condition is registered, the dictionary generation device for monitoring text information, including:

a feature degree calculation unit that calculates, for a phrase as a candidate for the detection condition, a feature degree representing a degree by which the phrase matches an information content targeted for monitor; and

a phrase usefulness determination unit that determines whether or not the phrase is appropriate for the detection condition based on the feature degree and a usefulness degree representing littleness of ambiguity of meaning defined by the phrase.

In the dictionary generation device for monitoring text information of the present invention, the phrase usefulness determination unit preferably includes:

a usefulness degree calculation unit which calculates the usefulness degree based on the length of a phrase; and

a detection condition determination unit which determines whether or not the phrase is appropriate for a detection condition based on the usefulness degree calculated by the usefulness degree calculation unit and on the feature degree.

In the dictionary generation device for monitoring text information of the present invention, the usefulness degree calculation unit more preferably calculates a usefulness degree based on the length of the phrase and on a frequency in a document group.

In general, the longer length of a phrase results in the less ambiguity of meaning and in a higher matching rate for a detection condition. In the present invention, priority is given to a phrase having a longer length by the configuration described above. As a result, it is possible to achieve high-precision detection compared to the conventional art.

For example,

the usefulness degree calculation unit calculates a usefulness degree based on the product of the length of a phrase or the logarithmic value thereof and a frequency in a document group or the logarithmic value thereof.

In the dictionary generation device for monitoring text information of the present invention, the usefulness degree calculation unit preferably calculates a usefulness degree based on the length of the phrase, a frequency in a document group, and an index representing an inclusion relationship between phrases.

More preferably,

when another phrase that is longer than a phrase of interest includes the phrase of interest,

the index representing an inclusion relationship between phrases is a ratio between the total of a frequency at which the other phrase appears and the number of the other phrase.

Consideration of the inclusion relationship results in the lower value of a phrase included in the other longer phrase, eliminates addition of a redundant detection condition, and enables improvement of dictionary precision.

In the dictionary generation device for monitoring text information of the present invention, preferably,

the detection condition determination unit determines whether or not a phrase is appropriate for a detection condition based on the product of the usefulness degree or the logarithmic value thereof and the feature degree or the logarithmic value thereof.

As a result, it is possible to carry out detection in consideration of a usefulness degree.

In the dictionary generation device for monitoring text information of the present invention, more preferably,

for a phrase of which the usefulness degree calculated by the usefulness degree calculation unit is not less than a threshold value,

the feature degree calculation unit calculates a feature degree, and

the detection condition determination unit determines whether or not the phrase is appropriate for a detection condition.

As a result, a calculation amount can be reduced while maintaining precision.

The present invention is a dictionary generation method for monitoring text information, which is a method for generating a dictionary used in a text information monitoring system,

wherein a dictionary generation device for monitoring text information

calculates, for a phrase as a candidate for a detection condition, a feature degree representing a degree by which the phrase matches an information content targeted for monitor;

determines whether or not the phrase is appropriate for the detection condition based on the feature degree and a usefulness degree representing littleness of ambiguity of meaning defined by the phrase; and

outputs a phrase judged to be appropriate and registers the phrase as the detection condition.

In the dictionary generation method for monitoring text information of the present invention, preferably,

the usefulness degree is calculated based on the length of a phrase; and

whether or not the phrase is appropriate for a detection condition is determined based on the usefulness degree and the feature degree.

More preferably, a usefulness degree is calculated based on the length of the phrase and on a frequency in a document group.

For example,

a usefulness degree is calculated based on the product of the length of a phrase or the logarithmic value thereof and a frequency in a document group or the logarithmic value thereof.

In the dictionary generation method for monitoring text information of the present invention, preferably,

a usefulness degree is calculated based on the length of the phrase, a frequency in a document group, and an index representing an inclusion relationship between phrases.

More preferably,

when another phrase that is longer than a phrase of interest includes the phrase of interest,

the index representing an inclusion relationship between phrases is a ratio between the total of a frequency at which the other phrase appears and the number of the other phrase.

In the dictionary generation method for monitoring text information of the present invention, preferably,

whether or not a phrase is appropriate for a detection condition is determined based on the product of the usefulness degree or the logarithmic value thereof and the feature degree or the logarithmic value thereof.

In the dictionary generation method for monitoring text information of the present invention, more preferably,

for a phrase of which the usefulness degree calculated by the usefulness degree calculation unit is not less than a threshold value,

a feature degree is calculated, and

whether or not the phrase is appropriate for a detection condition is determined.

The present invention is a dictionary generation program for monitoring text information, which causes a dictionary generation device for monitoring text information to execute

a processing of calculating, for a phrase as a candidate for a detection condition, a feature degree representing a degree by which the phrase matches an information content targeted for monitor;

a processing of determining whether or not the phrase is appropriate for the detection condition based on the feature degree and a usefulness degree representing littleness of ambiguity of meaning defined by the phrase; and

a processing of outputting a phrase judged to be appropriate and of registering the phrase as the detection condition.

The dictionary generation program for monitoring text information of the present invention preferably causes

a processing of calculating the usefulness degree based on the length of a phrase; and

a processing of determining whether or not the phrase is appropriate for a detection condition based on the usefulness degree and the feature degree

to be executed.

In the dictionary generation program for monitoring text information of the present invention, more preferably,

a usefulness degree is calculated based on the length of the phrase and on a frequency in a document group in the usefulness degree calculation processing.

For example,

a usefulness degree is calculated based on the product of the length of a phrase or the logarithmic value thereof and a frequency in a document group or the logarithmic value thereof in the usefulness degree calculation processing.

In the dictionary generation program for monitoring text information of the present invention, preferably,

a usefulness degree is calculated based on the length of the phrase, a frequency in a document group, and an index representing an inclusion relationship between phrases in the usefulness degree calculation processing.

More preferably,

when another phrase that is longer than a phrase of interest includes the phrase of interest,

the index representing an inclusion relationship between phrases is a ratio between the total of a frequency at which the other phrase appears and the number of the other phrase.

In the dictionary generation program for monitoring text information of the present invention, preferably,

whether or not a phrase is appropriate for a detection condition is determined based on the product of the usefulness degree or the logarithmic value thereof and the feature degree or the logarithmic value thereof in the detection condition determination processing.

In the dictionary generation program for monitoring text information of the present invention, more preferably,

for a phrase of which the usefulness degree calculated by the usefulness degree calculation processing is not less than a threshold value,

a feature degree is calculated in the usefulness degree calculation processing, and

whether or not the phrase is appropriate for a detection condition is determined in the detection condition determination processing.

This application is based upon and claims the benefit of priority from Japanese patent application No. 2012-213536, filed on Sep. 27, 2012, the disclosure of which is incorporated herein in its entirety by reference.

### REFERENCE SIGNS LIST

1 Phrase extraction unit
2 Phrase usefulness determination unit
3 Feature degree calculation unit
4 Output unit
21 Usefulness degree calculation unit
22 Detection condition determination unit

What is claimed is:

1. A dictionary generation device for monitoring text information, that is used in a text information monitoring system and generates a dictionary in which a detection condition is registered, the dictionary generation device comprising:
a feature degree calculation unit that calculates, for a phrase to be a candidate for the detection condition, a feature degree representing a degree by which the phrase matches an information content targeted for monitor; and
a phrase usefulness determination unit that determines whether or not the phrase is appropriate for the detection condition based on the feature degree and a usefulness degree representing littleness of ambiguity of meaning defined by the phrase.

2. The dictionary generation device for monitoring text information according to claim 1, wherein the phrase usefulness determination unit includes:
a usefulness degree calculation unit which calculates the usefulness degree based on the length of the phrase, and
a detection condition determination unit which determines whether or not the phrase is appropriate for a detection condition based on the usefulness degree calculated by the usefulness degree calculation unit and on the feature degree.

3. The dictionary generation device for monitoring text information according to claim 2, wherein
the usefulness degree calculation unit calculates a usefulness degree based on the length of the phrase and on a frequency in a document group.

4. The dictionary generation device for monitoring text information according to claim 3, wherein
the usefulness degree calculation unit calculates a usefulness degree based on the product of the length of the phrase or the logarithmic value thereof and a frequency in a document group or the logarithmic value thereof.

5. The dictionary generation device for monitoring text information according to claim 2, wherein
the usefulness degree calculation unit calculates a usefulness degree based on the length of the phrase, a frequency in a document group, and an index representing an inclusion relationship between phrases.

6. The dictionary generation device for monitoring text information according to claim 5, wherein
when another phrase that is longer than a phrase of interest includes the phrase of interest,
the index representing an inclusion relationship between phrases is a ratio between the total of a frequency at which the other phrase appears and the number of the other phrase.

7. The dictionary generation device for monitoring text information according to claim 2, wherein
the detection condition determination unit determines whether or not the phrase is appropriate for a detection condition based on the product of the usefulness degree or the logarithmic value thereof and the feature degree or the logarithmic value thereof.

8. The dictionary generation device for monitoring text information according to claim 2, wherein
for the phrase of which the usefulness degree calculated by the usefulness degree calculation unit is not less than a threshold value,
the feature degree calculation unit calculates a feature degree, and
the detection condition determination unit determines whether or not the phrase is appropriate for a detection condition.

9. A dictionary generation method for monitoring text information, that is a method for generating a dictionary used in a text information monitoring system,
wherein a dictionary generation device for monitoring text information
calculates, for a phrase as a candidate for a detection condition, a feature degree representing a degree by which the phrase matches an information content targeted for monitor;
determines whether or not the phrase is appropriate for the detection condition based on the feature degree and a usefulness degree representing littleness of ambiguity of meaning defined by the phrase; and
outputs the phrase judged to be appropriate and registers the phrase as the detection condition.

10. A non-transitory computer-readable storage medium storing a dictionary generation program for monitoring text information, that causes a dictionary generation device for monitoring text information to execute
a processing of calculating, for a phrase as a candidate for a detection condition, a feature degree representing a degree by which the phrase matches an information content targeted for monitor;
a processing of determining whether or not the phrase is appropriate for the detection condition based on the feature degree and a usefulness degree representing littleness of ambiguity of meaning defined by the phrase; and
a processing of outputting the phrase judged to be appropriate and of registering the phrase as the detection condition.
